(19) United States
(12) Patent Application Publication
(10) Pub. No.: US 2023/0067420 A1
(43) Pub. Date: Mar. 2, 2023

(54) INTELLIGENTLY GENERATING AND DEPLOYING A METRIC BLOCKLIST WITHIN A DISTRIBUTED COMPUTING SYSTEM TO EFFICIENTLY MANAGE DATA METRIC REQUESTS

(71) Applicant: Lyft, Inc., San Francisco, CA (US)

(72) Inventors: Behrooz Badii, Westport, CT (US); Yann Thomas Ramin, Folsom, CA (US)

(21) Appl. No.: 17/410,873

(22) Filed: Aug. 24, 2021

(51) Int. Cl. H04L 29/08

(52) U.S. Cl. CPC H04L 67/10; H04L 67/32

(57) ABSTRACT

The present disclosure relates to systems, non-transitory computer-readable media, and methods for improving the efficiency and flexibility of implementing computer devices by intelligently generating a metric blocklist based on predicted utilization of digital metrics and deploying the metric blocklist at one or more computing devices to limit digital metric requests to distributed databases. In particular, in one or more embodiments, the disclosed systems monitor historical digital metric utilization and apply a prediction model to generate a metric blocklist of digital metrics that are not likely to be utilized by one or more metric requesting devices of a distributed computing system. The disclosed systems can deploy the metric blocklist to computing devices of a distributed computing system to efficiently limit digital requests, processing resources, bandwidth consumption, and storage load with regard to utilization of metric storage devices (e.g., time-series databases).

### BACKGROUND

Recent years have seen significant improvements in data transmission and network management. For example, conventional observability systems can request, provide, and receive high volumes of metric data across networked environments. To illustrate, conventional systems can include various components that read data metrics from distributed data servers (e.g., time series databases) to generate reports or provide underlying data to support a wide range of applications. Similarly, conventional systems further include components that write new or updated data metrics reflecting observations or analytical results to the distributed data servers. Although conventional observability systems typically include the ability to utilize high numbers of data metrics in various ways, such systems have a number of technical problems, particularly with regard to efficiency and flexibility.

### BRIEF SUMMARY

Embodiments of the present disclosure provide benefits and/or solve one or more of the foregoing or other problems in the art with systems, non-transitory computer-readable media, and methods that improve the efficiency and flexibility of implementing computer devices by intelligently generating a metric blocklist based on predicted utilization of digital metrics and deploying the metric blocklist at one or more computing devices to limit digital metric requests to distributed databases. For example, the disclosed systems intelligently generate a blocklist of data metrics by analyzing historical interactions across computer networks to predict data metrics that are available to one or more computing devices within a distributed computing system (but not likely to be utilized by the one or more computing devices). The disclosed systems can intercept digital metric requests (e.g., at one or more gateways along a write request pipeline), compare the requested metric against the generated metric blocklist, and either deny or allow the request based on the comparison.

Thus, without requiring any revisions to the underlying source code of executables running within a distributed computer network, the disclosed systems can intelligently deploy a metric blocklist to significantly reduce bandwidth consumption, reduce processing load and storage requirements, improve latency, and diminish system disruptions. Indeed, the disclosed systems can reduce network traffic in observability systems by over 90% without significantly impacting access to digital metrics available within the ecosystem. Accordingly, the disclosed systems can dramatically improve the efficiency and flexibility of implementing computing devices and networks that utilize distributed storage resources (such as time-series databases).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a blocklist generation system can operate in accordance with one or more embodiments.

FIG. 2A illustrates one or more technological problems existing in prior art data management systems.

FIG. 2B illustrates one or more technological advantages of the blocklist generation system in accordance with one or more embodiments.

FIG. 3 illustrates an overview diagram of the blocklist generation system generating and utilizing a metric blocklist to intelligently gatekeep data metric requests in accordance with one or more embodiments.

FIG. 4 illustrates a sequence diagram of the blocklist generation system generating a metric blocklist based on a sample set of monitored digital requests in combination with information from other metric requesting devices within a distributed computing system in accordance with one or more embodiments.

FIG. 5 illustrates a sequence diagram of the blocklist generation system generating a metric blocklist based on generated metadata associated with monitored digital requests in combination with information from other metric requesting devices within a distributed computing system in accordance with one or more embodiments.

FIGS. 6A-6B illustrate one or more user interfaces generated by the blocklist generation system in accordance with one or more embodiments.

FIG. 7 illustrates a schematic diagram of a blocklist generation system in accordance with one or more embodiments.

FIG. 8 illustrates a flowchart of a series of acts for utilizing a blocklist to intelligently limit digital requests for digital metrics in accordance with one or more embodiments.

FIG. 9 illustrates a block diagram of an example computing device for implementing one or more embodiments of the present disclosure.

### DETAILED DESCRIPTION

This disclosure describes one or more embodiments of a blocklist generation system that improves the efficiency and flexibility of implementing computer devices by utilizing one or more models to predict digital metrics not likely to be utilized by one or more metric requesting devices of a distributed computing system, generating a metric blocklist of the predicted digital metrics, and deploying the generated metric blocklist across one or more client devices to alleviate network congestion and computing resource waste. For example, in one or more embodiments, the blocklist generation system predicts digital metrics available to metric requesting devices within a distributed computing system but likely to go unused based on targeted observations of digital metric requests over time. In at least one embodiment, the blocklist generation system generates a metric blocklist of the predicted digital metrics and compares the metric blocklist to received digital requests (e.g., digital write or read requests). In response to determining that a requested digital metric is referenced by the metric blocklist, the blocklist generation system blocks the digital request for that digital metric from being transmitted to a data server (i.e., a metric storage device). Utilizing this approach, the blocklist generation system can reduce bandwidth consumption within observability systems by over 90% while avoiding the inefficiency associated with modifying underlying source code that generate digital metric requests.

As mentioned above, the blocklist generation system intelligently generates a metric blocklist by predicting digital metrics that will likely go unused by one or more metric requesting devices within a distributed computing system. For example, in one or more embodiments, the blocklist generation system monitors digital requests for digital metrics made by metric requesting devices of the distributed computing system over time. From these monitored digital requests, the blocklist generation system generate a sample set of requested digital metrics. In at least one embodiment, the blocklist generation system utilizes a computer model to analyze the sample set and predict digital metrics that metric requesting devices of the distributed computing system will not utilize in the future.

In one or more embodiments, the blocklist generation system predicts digital metrics that will not be utilized based on a variety of features or factors. For example, in some embodiments, the blocklist generation system analyzes data from one or more sub-systems to identify pertinent or unused digital metrics. To illustrate, the blocklist generation system can analyze a metric report system within the distributed computing system that generates dashboards for client devices. The blocklist generation system can determine dashboard metrics utilized or scheduled to be utilized in these dashboards (e.g., queries that are part of the dashboards that reference one or more metrics) in generating the metric blocklist. Similarly, the blocklist generation system can analyze an alerting system that generates alerts. The blocklist generation system can determine alert metrics utilized or scheduled to be utilized by these alerts (e.g., queries that are part of alerts that reference one or more metrics) in generating the metric blocklist. In at least one embodiment, the blocklist generation system predicts digital metrics that will not be utilized by analyzing the sample set of observed digital metric requests in view of the dashboard metrics and/or the alert metrics.

In some embodiments, the blocklist generation system predicts digital metrics that will not be utilized based on an analysis of metadata generated in connection with digital metric requests over time. For example, in some embodiments the blocklist generation system analyzes metadata for received digital metric requests over a threshold period of time. To illustrate, the blocklist generation system generates, maintains, and updates metadata for a received digital metric request including: a timestamp for when the requested digital metric was first read from a data server, a timestamp for when the requested digital metric was last read from the data server, a timestamp for when the requested digital metric was first written to the data server, and/or a timestamp for when the requested digital metric was last written to the data server. The blocklist generation system can predict unutilized digital metrics based on an analysis of the generated metadata associated with the requested digital metrics (e.g., by analyzing digital metrics that have been utilized and/or are likely to be utilized in the future).

In one or more embodiments, the blocklist generation system generates a metric blocklist based on the predicted, unutilized digital metrics. For example, in one or more embodiments, the blocklist generation system generates the metric blocklist including all of the digital metrics predicted to not be utilized by one or more metric requesting devices of the distributed computing system. Additionally or alternatively, in an embodiment where the blocklist generation system generates prediction scores associated with the digital metrics, the blocklist generation system generates the metric blocklist including digital metrics with prediction scores that satisfy or exceed a threshold prediction score.

As mentioned, the blocklist generation system can also deploy the metric blocklist to one or more computing devices within a request pipeline of the distributed computing system. For example, in at least one embodiment, the blocklist generation system maintains and accesses the metric blocklist at a network gateway of the distributed computing system. In additional or alternative embodiments, the blocklist generation system maintains and accesses the metric blocklist at one or more metric requesting devices of the distributed computing system. In additional or alternative embodiments, the blocklist generation system maintains and accesses the metric blocklist at one or more sub-systems of the distributed computing system, such as but not limited to a metric report system or an alerting system hosted by one or more metric requesting devices within the distributed computing system.

In one or more embodiments, the blocklist generation system utilizes the metric blocklist in response to receiving a request associated with one or more digital metrics. To illustrate, in one or more embodiments the blocklist generation system identifies a write-request for a digital metric at the network gateway of the distributed computing system and then compares the requested digital metric to the digital metrics referenced by the metric blocklist. In response to determining that the requested digital metric is referenced by the metric blocklist, the blocklist generation system blocks the request from passing through the network gateway to an external data server (e.g., a metric storage device). Alternatively, in response to determining that the requested digital metric is not referenced by the metric blocklist, the blocklist generation system allows the request to pass through the network gateway to the external data server.

In additional or alternative embodiments, the blocklist generation system utilizes additional techniques to block digital requests for unutilized digital metrics. For example, in one or more embodiments, the blocklist generation system blocks requests for unchanged digital metrics, but allows requests for digital metrics that have experienced a state change from the last time they were either written or read to a metric storage device. To illustrate, rather than allowing multiple write requests for a digital metric including the same value (e.g., multiple write requests for a digital metric with a value of “0”), the blocklist generation system allows write requests for that digital metric only when the value of that digital metric changes from the last write requests (e.g., when the value of the digital metric changes from a “0” to “1”).

In one or more embodiments, the blocklist generation system further generates notifications associated with the generated blocklist. For example, in one or more embodiments, in response to blocking a digital metric request from a metric requesting device, the blocklist generation system generates a notification regarding the blocked digital metric and provides the notification to the metric requesting device. In at least one embodiment, the blocklist generation system additionally provides an option within the notification for the blocked digital metric to be allowed. For example, in response to a detected selection of the option to allow requests for the blocked digital metric, the blocklist generation system either adds the digital metric to an allowed list or removes the digital metric from the metric blocklist.

As illustrated by the foregoing discussion, the present disclosure utilizes a variety of terms to describe features and advantages of the blocklist generation system. For example, as used herein, the term “distributed computing system” refers to a system of computing devices that function in concert (e.g., across a computer network). In one or more embodiments, the blocklist generation system manages digital metric requests within and among members of a distributed computing system. For example, a distributed computing system can include metric requesting devices (that send read and/or write requests corresponding to digital metrics) and metric storage devices (that store and provide digital metrics). As discussed in greater detail below, a distributed computing system can include a variety of devices, including metric requesting devices, a network gateway, a metric report system, an alerting system, and metric storage devices.

As used herein, a metric requesting device refers to a computing device (e.g., an end-user terminal or a server) that originates, generates, or transmits one or more requests associated with one or more digital metrics. Additionally, a network gateway refers to a computing device (e.g., a proxy server) that receives network requests from one or more computing devices and passes those requests to one or more servers (e.g., metric storage devices). For example, a network gateway can connect an internal network to an external network such as the Internet. Moreover, a metric report system refers to a configurable system that generates various types of predefined metric-based reports. For example, a metric report system can generate one or more pre-configured dashboards (e.g., visual displays) of analytical results built on requested digital dashboard metrics.

Furthermore, an alerting system refers to one or more computer devices that generate one or more alerts (e.g., in response to determining one or more predefined conditions or triggers are satisfied). For example, the alerting system requests digital alert metrics and feeds the requested digital metrics through rules, heuristics, levels, or other checkpoints to generate one or more alerts. In response to determining that the requested digital metrics satisfy the rules, heuristics, levels, or other checkpoints, the alerting system generates one or more alerts such as, but not limited to, display notifications, log file entries, automatic digital communications (e.g., emails, SMS messages), or changes to existing displays (e.g., changing a text color, outlining a display elements, flashing a display element). As used herein, metric storage devices refer to computing devices (e.g., data servers) that storage, manage, and/or provide digital metrics (e.g., receive and process digital metric requests). For example, a metric storage device can receive and fulfill a digital metric request to receive and write a digital metric to storage. Similarly, a metric storage device can receive and fulfill a digital metric request to read and provide a digital metric from storage. In one or more embodiments, a metric storage device refers to one or more servers that manage a time-series database.

As used herein, “digital metrics” refer to digital information that is transferable over a computing network. In one or more embodiments, a digital metric is organized into a data structure including a metric label (e.g., a name) and one or more metric values (e.g., tags) associated with that name (e.g., a key-value pair). In some embodiments, digital metrics are stored within a time-series database (e.g., key-value pairs where the value changes across time). For example, the metric label and/or metric value(s) associated with a digital metric can include alpha-numeric characters, strings, Boolean values, hash values, and so forth. In one or more embodiments, a digital metric is associated with a metric type. For example, a digital metric can be a gauge (e.g., current CPU load), a counter (e.g., a number of transportation requests), or a timer (e.g., latency of last request). Some examples of common digital metrics include, but are not limited to: CPU usage (e.g., a label referencing usage with a corresponding usage value), memory usage, file disk usage. A digital metric can also include one or more tags that provide additional detail. To illustrate a digital metric can include a tag identifying a location corresponding to the metric.

In at least one embodiment, a digital metric is associated with a cardinality level. For example, a digital metric with high-cardinality is a metric associated with a large amount of data (e.g., a metric associated with one or more strings of characters). A digital metric with low-cardinality is a metric associated with a small amount of data (e.g., a true/false metric). In one or more embodiments, a digital metric is also associated with a metric type. For example, a digital metric can be a gauge (e.g., current CPU load), a counter (e.g., a number of transportation requests), or a timer (e.g., latency of last request). Some examples of commonly requested digital metrics include, but are not limited to: CPU usage (e.g., a label referencing usage with a corresponding usage value), memory usage, file disk usage.

As used herein, a “metric blocklist” refers to a data structure that identifies digital metric requests to control. For example, a metric blocklist can indicate one or more digital metrics to block, filter, or prevent. For instance, a metric blocklist can include a list, array, string, or vector referencing metrics predicted to go unutilized by one or more computing devices. In one or more embodiments, the blocklist generation system generates a metric blocklist as a comma separated file including names of digital metrics whose associated requests should be blocked. In other embodiments, the blocklist generation system generates a metric blocklist as a hash map, a linked list, or any other suitable data structure. The blocklist generation system can compress a metric blocklist, encode, copy, and/or distribute a metric blocklist to one or more devices within a distributed computing system.

Although referred to throughout in terms of a “blocklist” for blocking digital metrics, a metric blocklist also includes a list of digital metrics to allow. In other words, even if implemented as a list of digital metrics to allow, the term blocklist still encompasses this implementation as a data structure that identifies digital metric requests to control. Similarly, a metric blocklist can also include a data structure that is utilized to control digital metrics in other ways. For example, a metric blocklist can include a data structure identifying digital metrics archive, batch upload, or buffer.

As used herein, a “sample set” refers to a selection or sample of digital metrics. In particular, a sample set of digital metrics can include a set of metrics monitored or observed (e.g., within metric requests) over a threshold period of time. In one or more embodiments, the blocklist generation system generates metadata associated with digital metrics in a sample set. For example, the blocklist generation system generates metadata including, but not limited to: a first-read timestamp (e.g., when the metric was first read from a metric storage device), a last-read timestamp (e.g., when the metric was last read from the metric storage device), a first-write timestamp (e.g., when the metric was first written to the metric storage device), and/or a last-write timestamp (e.g., when the metric was last written to the metric storage device).

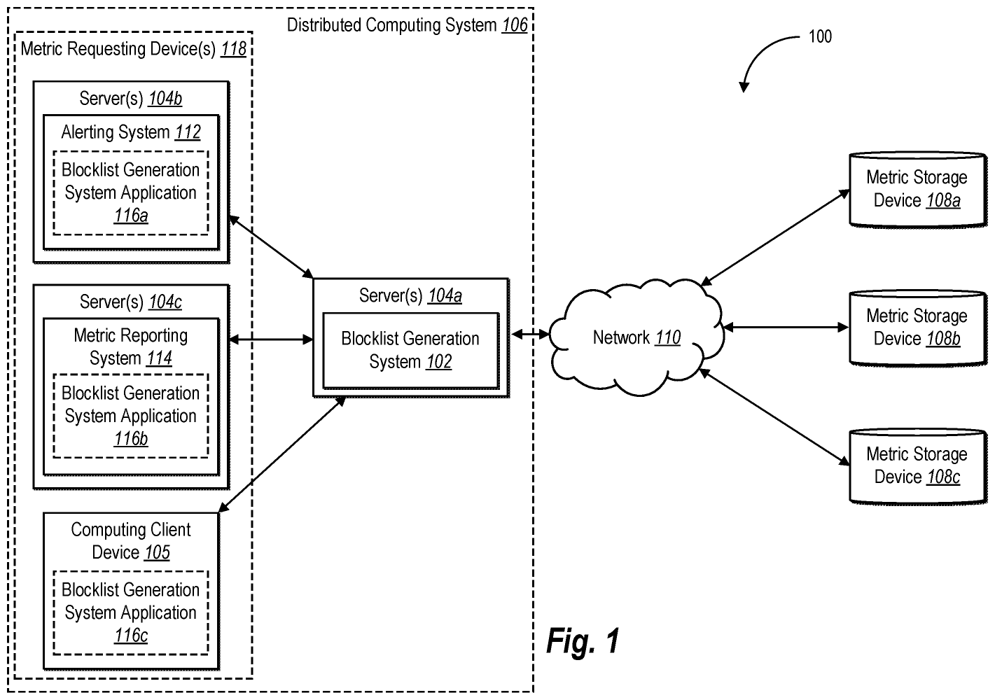

Turning now to the figures, FIG. 1 illustrates a schematic diagram of an environment 100 for implementing a blocklist generation system 102 in accordance with one or more embodiments. As shown in FIG. 1, the environment 100 includes a server(s) 104a hosting the blocklist generation system 102, metric requesting devices 118, a network 110, and metric storage devices 108a, 108b, and 108c. In one or more embodiments, the metric requesting device(s) 118 and the server(s) 104a exist within a distributed computing system 106. In additional or alternative embodiments, the distributed computing system 106 can include additional, fewer, or different computing devices.

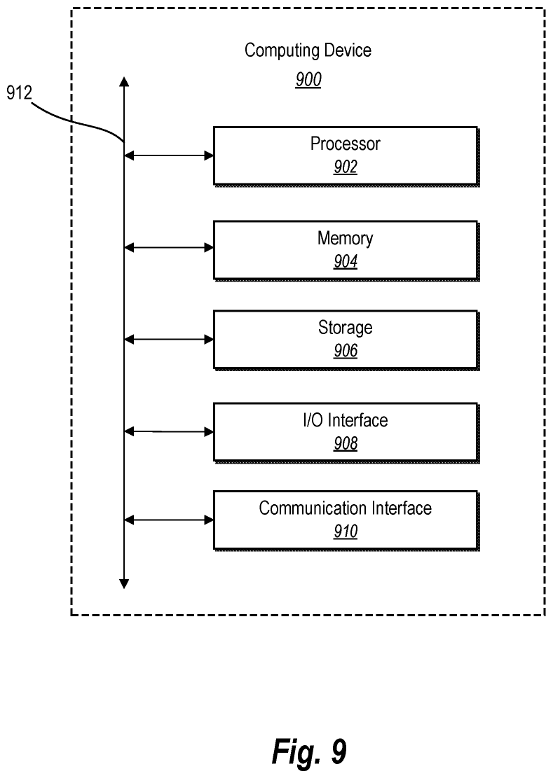

As suggested above, the metric requesting devices 118 include one or more servers (e.g., the server(s) 104b and 104c) hosting one or more systems (e.g., an alerting system 112, a metric reporting system 114), as well as one or more client computing devices (e.g., a computing client device 105). The metric requesting device(s) 118 may comprise a mobile device (such as a laptop, smartphone, or tablet), a laptop computer, a desktop computer, or a server (e.g., a file server, a web server). Additional information associated with the metric requesting devices 118 is provided below with reference to FIG. 9.

As mentioned above, the server(s) 104a hosts the blocklist generation system 102. For example, in one or more embodiments the server(s) 104a is a gateway server within the environment 100 such that digital requests for digital metrics from one or more of the metric requesting device(s) 118 pass through the server(s) 104a prior to being sent to one or more of the metric storage devices 108a-108c. Accordingly, in one or more embodiments, the blocklist generation system 102 on the server(s) 104a gatekeeps the digital requests passing through the server(s) 104a to prevent or block digital requests for digital metrics that the metric requesting device(s) 118 will not utilize (e.g., according to an intelligently generated blocklist). Additionally, in one or more embodiments, the blocklist generation system 102 hosted by the server(s) 104a monitors digital requests for digital metrics from the metric requesting device(s) 118 to generate and/or update a metric blocklist.

Additionally, in at least one embodiment, the blocklist generation system 102 provides “hot storage” in connection with requests for digital metrics. For example, the blocklist generation system 102 can temporarily store (e.g., for a period of 7 days, for a period of 2 weeks) the digital metrics associated with write requests form the metric requesting device(s) 118 instead of transmitting those digital metrics to one or more of the metric storage devices 108a-108c. The blocklist generation system 102 can further provide the temporarily stored digital metrics in response to read requests from the metric requesting device(s) 118. Thus, in that embodiment, the blocklist generation system 102 prevents metric requests from being transmitted to the metric storage devices 108a-108c in most instances.

As mentioned above, the blocklist generation system 102 can generate and deploy blocklists across a variety of computing devices. For example, as shown in FIG. 1, the metric requesting devices 118 can include a blocklist generation system application 116a, 116b, or 116c, respectively. For example, in at least one embodiment, the blocklist generation system applications 116a-116c perform similar functions and features of the blocklist generation system 102. For example, in one or more embodiments, the blocklist generation system applications 116a-116c prevent digital requests originating from the alerting system 112, the metric reporting system 114 and/or the computing client device 105. Additionally, in one or more embodiments, the blocklist generation system applications 116a-116c monitor digital requests for metrics from associated metric requesting device(s) 118 to generate and/or update the metric blocklist.

In one or more embodiments, the blocklist generation system 102 determines that a digital metric referenced by a digital request is not associated with an intelligently generated metric blocklist and allows the digital request to proceed to one or more of the metric storage devices 108a-108c across a network 110. Additionally, the one or more metric storage devices 108a-108c transmit requested digital metrics and other information (e.g., read/write status updates) via the network 110. The network 110 may be any suitable network over which computing devices communicate. Example networks are discussed in more detail below in relation to FIG. 9.

Furthermore, in one or more embodiments, the metric storage devices 108a-108c are computing devices such as data servers that read and write digital metrics to storage (e.g., temporary or long-term storage) in response to requests from the metric requesting device(s) 118. For instance, the metric storage devices 108a-108c may store time-series databases that include key-value pairs (e.g., where the value changes across time). Additionally or alternatively, any of the metric storage devices 108a-108c is a file server (e.g., an FTP server), or a web server.

Although not illustrated in FIG. 1, in some embodiments, the environment 100 may have a different arrangement of components and/or may have a different number or set of components altogether. For example, the environment 100 may include a different number of computing client devices 105, and/or additional systems beyond the alerting system 112 and metric reporting system 114. Moreover, the server(s) 104a-104c may include multiple systems. For instance, in one or more embodiments, the server(s) 104a hosts the blocklist generation system 102, the alerting system 112, and the metric reporting system 114.

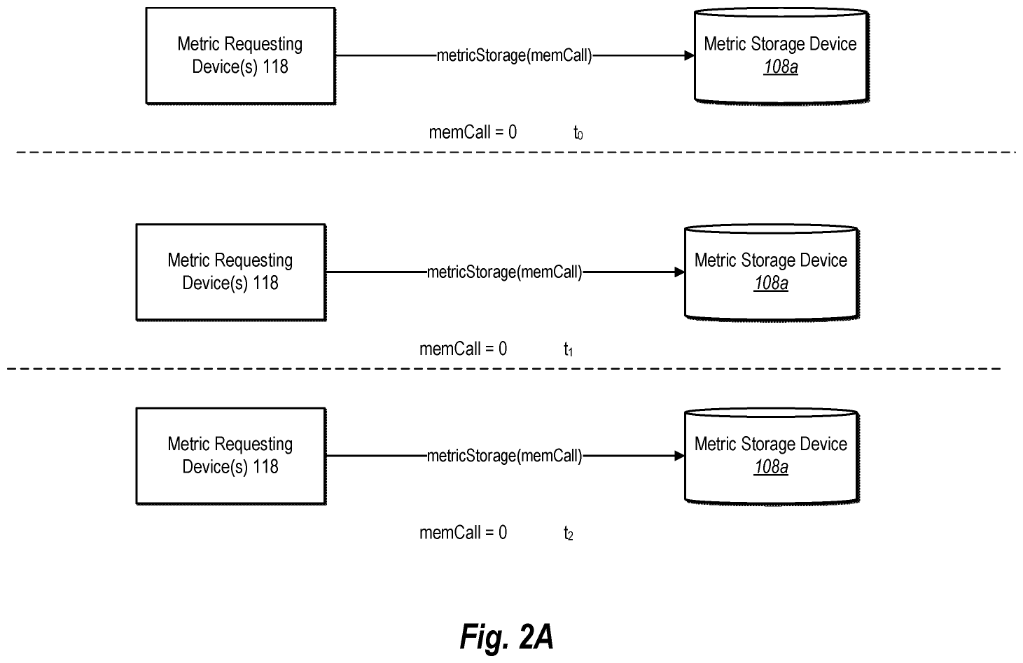

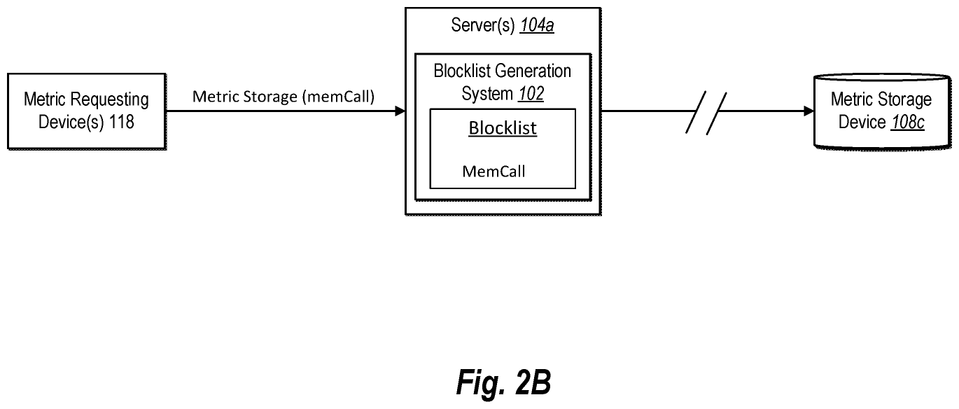

As mentioned above, conventional systems suffer from a variety of drawbacks in relation to flexibility and efficiency of implementing computing devices. For example, FIG. 2A illustrates one or more drawbacks of conventional systems, while FIG. 2B illustrates one or more advantages of the blocklist generation system 102 over conventional systems. In more detail, conventional systems conventional systems are generally rigid and inflexible in their treatment of requests to read and write data metrics. To illustrate, conventional systems originate metric requests at executables running on requesting devices and require individual modification of those executables to limit metric storage and/or retrieval.

For example, in one or more embodiments as shown in FIG. 2A, a user of a metric requesting device 118 can author source code, which is further compiled into an executable on the metric requesting device 118. The source code includes a number of programming statements that embody metric requests. For example, the source code includes a programming statement embodying a metric request (e.g., “metricStorage(memCall)”). When compiled into an executable, and at run-time, the metric request embodied in this programming statement causes the metric requesting device 118 to transmit a metric request for the digital metric “memCall” to at least one of the metric storage devices 108a-108c.

Often, source code[′includes metric requests for digital metrics that are ultimately not utilized by the metric requesting device 118 (or any other metric requesting device). For example, even though the source code executed from the metric requesting device(s) 118 shown in FIG. 2A includes a repetitive process for reading and/or writing the digital metric “memCall,” the metric requesting device 118 (and other metric requesting devices) may not utilize the digital metric “memCall” in the future. Because software engineers are often trained to export digital metrics as a matter of course, such digital metric requests are a common issue in connection with software applications including thousands and even millions of lines of source code, and give rise to a range of technological problems.

These issues are compounded when the same metric requests are repeatedly made by the metric requesting device(s) 118. For example, as shown in FIG. 2A, the source code executed from the metric requesting device(s) 118 repeatedly requests that a metric “memCall” be written to the metric storage device 108a at times t₀, t₁, and t₂, even though the value of the metric “memCall” remains zero. In additional embodiments, the source code executed from the metric requesting device(s) 118 may repeatedly make requests for metrics with changing values, or values that remain static for a threshold amount of time. Regardless of the value of the requested metric, these repeated metric requests waste system resources when the requested metrics are not utilized by any of the metric requesting device(s) 118.

To remedy this issue, conventional systems often require that software code be manually policed and modified to reduce unnecessary data requests. For example, a conventional system addresses the repetitive metric request for the metric “memCall” illustrated in FIG. 2A by requiring an administrator device to edit the associated source code to remove or otherwise deactivate this metric request. The administrator device then re-compiles the edited source code and re-deploys the resulting executable. This process is extremely inefficient, as computer systems are often running millions of executables across client devices that are generated and managed by various teams of administrator devices. Thus, conventional systems expend exorbitant resources to identify and correct extraneous metric requests, even while additional metric requests are added as executables are added or modified. Moreover, even where engineers are able to remove extraneous metric requests, this rigid approach typically leads to additional inefficiencies in the future. For example, when data metrics previously referenced by removed data requests are again needed, the software code must again be modified to include the once-removed data requests.

Because this rigid approach is burdensome and difficult to enact in connection with source code including many files, modules, libraries, and lines of code, such frivolous metric requests generally remain unaddressed. Accordingly, conventional systems typically experience additional technical problems with regard to efficiency and accuracy of implementing computing devices. For example, conventional systems inefficiently utilize computing resources by overburdening network resources in the course of fulfilling read and write requests associated with data metrics that ultimately go unused. More specifically, conventional systems waste network bandwidth in writing and storing data metrics that serve no ultimate purpose.

Additionally, conventional systems waste additional computing resources in processing voluminous data requests. For instance, as mentioned above, conventional systems frequently request to write data metrics that are ultimately unused by any module, component, or function within the conventional systems. Accordingly, conventional systems waste computer processor resources in processing these frivolous requests, as well as computer memory resources in storing—either in long or short-term memory—the data metrics. Conventional systems waste further computer processor resources in ensuring that these frivolous data metric requests are correctly packaged and routed for transmission across the network to one or more outside data servers. In addition, conventional systems also utilize significant computing resources in indexing digital metrics in memory devices and corresponding databases.

Furthermore, conventional systems also suffer from latency and operability problems. As discussed above, conventional systems commonly generate write requests associated with data metrics that are not used. The network traffic created by these inefficient requests often lead to increased latency and system disruptions associated with voluminous data metric request. For example, the high network traffic and ensuing network lag generated by inefficient requests ultimately results in read/write misfires, where a computing devices receives a requested data metric outside of a timeframe where that data metric accurately reflects a particular value, computational state, or characteristic. The computing device is accordingly forced to wait for the data metric to be produced, disrupt an ongoing process, or proceed by inaccurately performing a particular task (e.g., a calculation, a display, an analysis) based on the expired data metric.

The blocklist generation system 102 improves efficiency and flexibility relative to these conventional systems. For example, the blocklist generation system 102 improves the efficiency of implementing systems by streamlining the use of networking resources. To illustrate, rather than simply passing metric read and write requests through to metric storage devices, the blocklist generation system 102 generates and utilizes a metric blocklist that dictates metric requests that should be blocked and/or permitted. For example, as shown in FIG. 2B, the blocklist generation system 102 compares metric requests received from a metric requesting device 118 against a metric blocklist, and either allows or denies the metric request prior to the metric storage device 108c receiving the metric request. As such, the blocklist generation system alleviates network strain caused by requests for metrics that ultimately go unused within the distributed computing system. The blocklist generation system similarly reduces the computing waste associated with processing frivolous metric requests and storing digital metrics received in response to those requests.

Additionally, the blocklist generation system 102 enhances the latency and operability of implementing systems. For example, the blocklist generation system 102 reduces system latency by focusing processing resources on metric requests that are predicted to be used by one or more components of the distributed computing system. This increase in overall system speed leads to additional accuracies by ensuring that metric requesting devices receive their requested metrics within relevant timeframes. Accordingly, the blocklist generation system 102 can avoid system and/or process disruptions by providing pertinent digital metrics within critical network traffic limits.

Moreover, the blocklist generation system 102 improves the flexibility of implementing systems by providing a customized solution to metric requests for unused metrics. For example, rather than requiring coding changes to reduce requests (e.g., such as described above with regard to FIG. 2A), the blocklist generation system 102 utilizes a flexible metric blocklist that is intelligently tailored and adaptable to currently predicted needs of the distributed computing system. If one or more digital metrics need to be removed from the metric blocklist at any point, the blocklist generation system provides an efficient approach to remove the digital metrics from the metric blocklist and allow digital requests to pass through to one or more of the metric storage devices 108a-108c.

The computer-based improvements provided by the blocklist generation system 102 directly contribute to system-wide reductions in bandwidth and storage needs. For example, as mentioned above, conventional systems eat up bandwidth within a distributed system with numerous and frequent requests associated with digital metrics that may or may not be used by any metric requesting device. In contrast to this, some embodiments of the blocklist generation system 102 have shown a 90% reduction in bandwidth consumption across the distributed computing system 106. Depending on its configuration, some embodiments of the blocklist generation system 102 have demonstrated at least a ten-times (10×) reduction in computing resource use (e.g., processor use, network bandwidth, memory use) in response to utilizing a metric block list.

The blocklist generation system 102 can also utilize additional approaches to further reduce computational resources. For example, in some embodiments the blocklist generation system 102 utilizes a rate-limiting approach to reduce digital requests. In particular, the blocklist generation system 102 places a threshold limit on the number of requests for a particular digital metric (e.g., from a particular source).

Similarly, in some embodiments, the blocklist generation system 102 utilizes an elision approach that blocks or ceases digital requests for metrics that are a particular value (e.g., repeat values that do not change and/or “zero”/“null” values). In some embodiments, the blocklist generation system 102 adds such metrics to the blocklist. Moreover, the blocklist generation system 102 can also target, block, limit or remove high cardinality metrics. For instance, the blocklist generation system 102 can identify a high cardinality value name (e.g., with a threshold number of characters) and remove the digital metric (or add the digital metric to a blocklist).

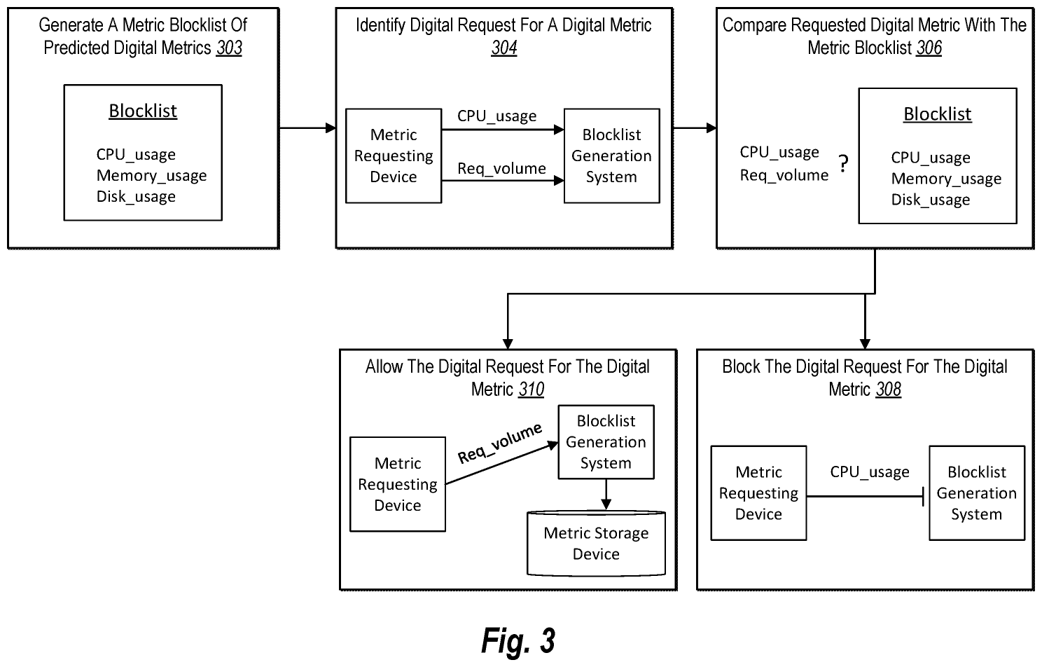

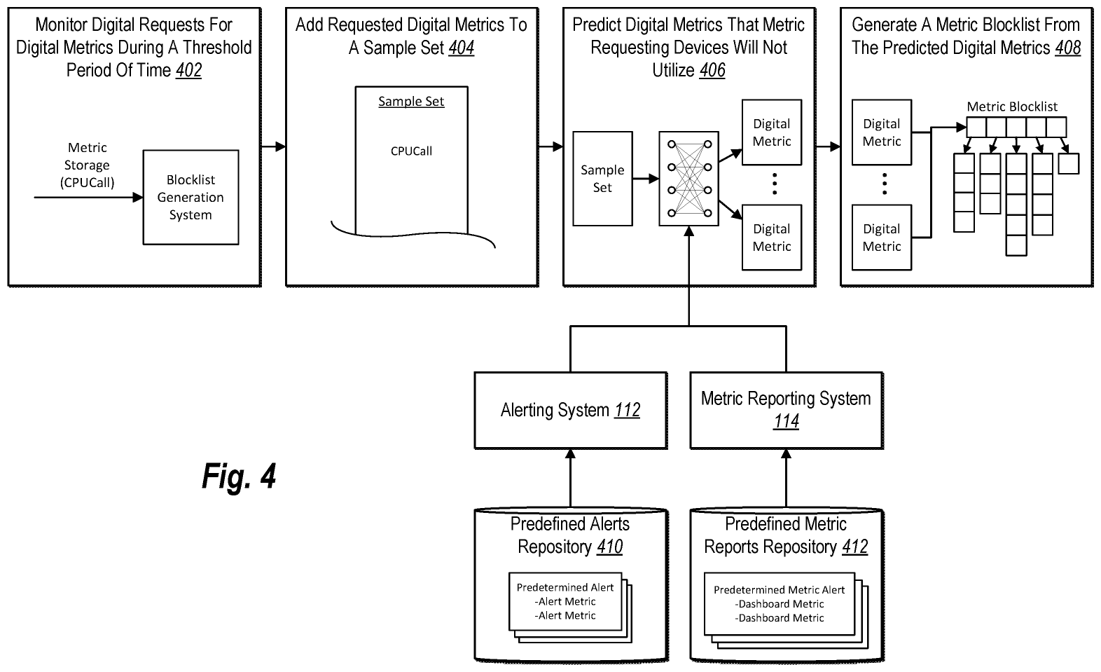

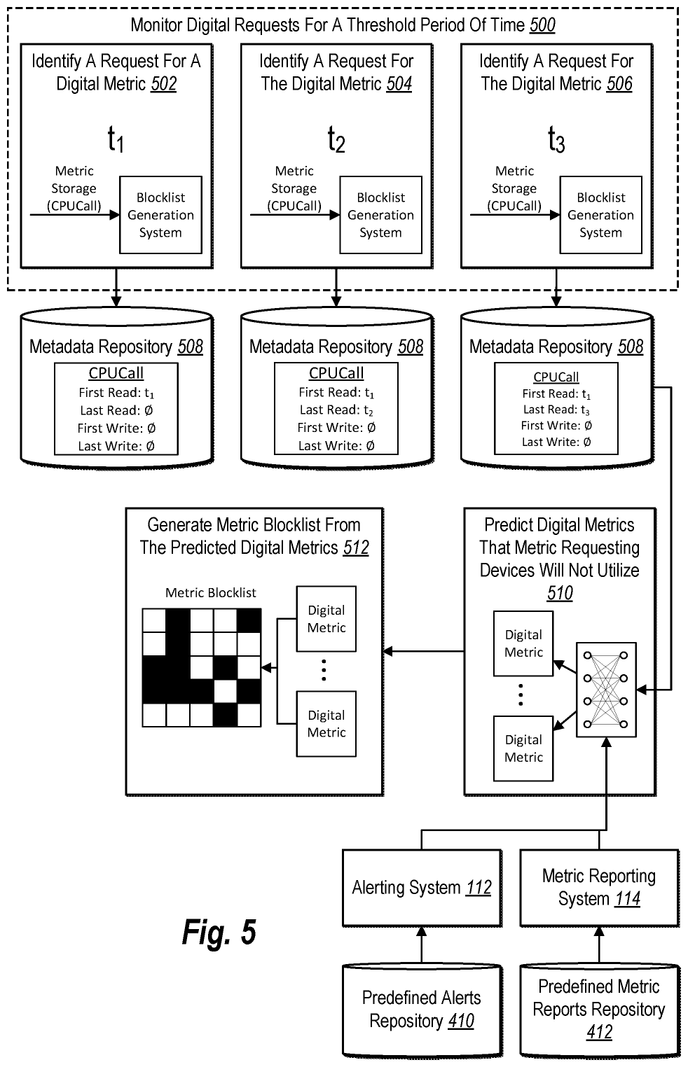

As discussed above, the blocklist generation system 102 generates computational efficiencies by predicting digital metrics that metric requesting devices will not utilize, and intelligently blocking requests for those predicted digital metrics. For example, FIG. 3 illustrates an overview diagram of the blocklist generation system 102 utilizing a blocklist of predicted digital metrics to improve the accuracy and efficiency of a distributed computing system. To illustrate, in one or more embodiments, the blocklist generation system 102 performs an act 303 of generating a metric blocklist of predicted digital metrics. In one or more embodiments, and as will be discussed in greater detail below with regard to FIGS. 4 and 5, the blocklist generation system 102 generates the metric blocklist by monitoring metric requests for a threshold period of time, and predicting digital metrics that will not be utilized by requesting computing device based on the monitored metric requests. In at least one embodiment, the blocklist generation system 102 further identifies digital metric that will not be utilized based on information corresponding to one or more of the metric requesting device 118 (e.g., repositories of digit metrics that can be read or written by the alerting system 112), and/or additional use-metadata associated with the monitored digital metric requests.

Additionally, as shown in FIG. 3, the blocklist generation system 102 performs an act 304 of identifying a digital request for a digital metric. For example, in one or more embodiments, the blocklist generation system 102 identifies a digital request for a digital metric in response to receiving the digital request from one of the metric requesting devices 118 (e.g., at a network gateway). In an additional embodiment, the blocklist generation system 102 identifies the digital request for the digital metric in response to detecting a system call from an executable that requests a digital metric. For example, the blocklist generation system 102 operates via a blocklist generation system application 116 installed on one of the metric requesting devices 118.

The blocklist generation system 102 further performs an act 306 of comparing the requested digital metric with the metric blocklist. For example, in one or more embodiments, the blocklist generation system 102 compares the requested metric with the metric blocklist to determine whether the requested metric exists on or is referenced by the metric blocklist. In one or more embodiments, the blocklist generation system 102 compares the requested metric with the metric blocklist by performing string comparison. Additionally or alternatively, the blocklist generation system 102 determines whether the requested digital metric is referenced by the metric blocklist by generating a hash or encoding and determining whether a matching hash or encoding exists in the metric blocklist.

Based on the comparing the requested digital metric with the metric blocklist, the blocklist generation system 102 performs the acts 308 and 310. For example, in response to determining that the requested digital metric exists on or is referenced by the metric blocklist, the blocklist generation system 102 performs the act 308 of blocking the digital request for the digital metric. In one or more embodiments, the blocklist generation system 102 blocks the digital request at a network gateway or proxy server by not transmitting the received digital request for the digital metric to one or more of the metric storage devices 108a-108c. In another embodiment, the blocklist generation system 102 (e.g., via the blocklist generation system application 116) blocks the digital request at one of the metric requesting device(s) 118 by failing to originate or instantiate a system call requesting the digital metric.

Additionally, in response to determining that the requested digital metric does not exist on the metric blocklist, the blocklist generation system 102 performs the act 310 of allowing the digital request for the digital metric. For example, in one or more embodiments, the blocklist generation system 102 allows a read request for the digital metric and/or a write request for the digital metric. In at least one embodiment, the blocklist generation system 102 allows the digital request for the digital metric by allowing the digital request to either initialize at a metric requesting device 118, or by allowing the digital request to pass through the network gateway to one or more of the metric storage devices 108a-108c.

As mentioned above, the blocklist generation system 102 intelligently generates a metric blocklist by predicting digital metrics that the metric requesting devices 118 will not utilize. FIGS. 4 and 5 illustrate sequence diagrams of the blocklist generation system 102 predicting these unutilized digital metrics in generating a metric blocklist. For example, FIG. 4 illustrates a sequence diagram of the blocklist generation system 102 generating a metric blocklist in response to predicting frivolous digital metrics based on monitored metric requests in combination with additional information from systems within the distributed computing system. Additionally, FIG. 5 illustrates a sequence diagram of the blocklist generation system 102 generating a metric blocklist in response to predicting digital metrics that will not be utilized based on generated metadata associated with monitored metric requests.

In more detail, as shown in FIG. 4, the blocklist generation system 102 performs an act 402 of monitoring digital requests for digital metrics during a threshold period of time. For example, the blocklist generation system 102 monitors digital requests for digital metrics by identifying the digital metrics reference by digital requests received from one or more of the metric requesting devices 118 during the threshold period of time. To illustrate, during a threshold period of minutes (e.g., 30 minutes, 60 minutes, 90 minutes), hours (e.g., 12 hours, 24 hours, 36 hours), days (e.g., 30 days, 60 days, 90 days), months (e.g., 3 months, 6 months), or years (e.g., 1 year, 2 years), the blocklist generation system 102 identifies digital requests for digital metrics transmitted from one or more metric requesting devices 118 within the distributed computing system 106.

In response to identifying digital requests for digital metrics, the blocklist generation system 102 performs an act 404 of adding requested digital metrics to a sample set. For example, during the threshold period of time, the blocklist generation system 102 adds each digital metric referenced by an identified digital request to the sample set. Accordingly, once the threshold period of time elapses, the sample set includes a list of digital metrics that were requested by the metric requesting devices 118 during the threshold period of time. In one or more embodiments, the blocklist generation system 102 generates the sample set including each digital metric that was requested at least once during the threshold period of time.

Furthermore, in one or more embodiments, the blocklist generation system 102 generates the sample set including tags of the digital metrics requested during the threshold period of time. In additional embodiments, the blocklist generation system 102 generates the sample set including both the requested digital metric names as well as any specifically requested attribute of the named digital metrics (e.g., tag names of the digital metrics). Accordingly, the blocklist generation system 102 can generate a blocklist based on the metric names and/or based on these tags. This allows the blocklist generation system 102 to block a subset of a certain digital metric (e.g., block a digital metric that originates from a San Diego with a San Diego tag but allow the same digital metric if it originates from San Francisco with a San Francisco tag).

In additional or alternative embodiments, the blocklist generation system 102 generates the sample set including a count associated with each requested digital metric, such that the blocklist generation system 102 increases a count for a particular digital metric every time that digital metric is requested during the threshold period of time. In yet additional or alternative embodiments, the blocklist generation system 102 generates the sample set including a timestamp associated with each requested digital metric.

The blocklist generation system 102 further performs an act 406 of predicting digital metrics that metric requesting devices will not utilize. In one or more embodiments, the blocklist generation system 102 predicts these unutilized digital metrics in various ways. For example, in one or more embodiments, the blocklist generation system 102 predicts unutilized digital metrics based on the generated sample set. For example, the blocklist generation system 102 utilizes one or more models (e.g., computer-implemented rules, heuristics, algorithms, machine learning approaches) to predict unutilized digital metrics based on the sample set and/or counts associated with the digital metrics. To illustrate, the blocklist generation system 102 can predict that digital metrics with counts lower than a predetermined amount will not be utilized by the metric requesting devices 118. Additionally or alternatively, the blocklist generation system 102 can predict that digital metrics with timestamps older than a predetermined amount of time (e.g., older than 6 months) will not be utilized by the metric requesting devices 118. Additionally or alternatively, the blocklist generation system 102 predicts that digital metrics associated with write requests but no corresponding read requests within a threshold amount of time will not be utilized by the metric requesting devices 118.

In additional embodiments, the blocklist generation system 102 further predicts unutilized digital metrics based on the sample set in combination with information from one or more of the metric requesting devices 118. For example, in one or more embodiments, the blocklist generation system 102 predicts unutilized digital metrics in connection with the sample set and one or more predefined metric reports associated with the metric reporting system 114. To illustrate, the blocklist generation system 102 can query or request a list of dashboard metrics referenced by predefined metric reports available via the metric reporting system 114. For example, a developer can generate a dashboard with a plurality of saved queries that may be used in the future as part of a particular dashboard. These queries can reference one or more metrics. The metric reporting system 114 can add these metrics to a metric repository. Accordingly, dashboard metrics referenced by one or more predefined metric reports can include metrics explicitly referenced within a metric report (e.g., a dashboard) or included within a query corresponding to the metric report.

In such an embodiment, the metric reporting system 114 maintains a predefined metric reports repository 412 (e.g., a git repository) of predefined metric reports; each predefined metric report referencing one or more dashboard metrics. For example, utilizing the predefined metric reports in the predefined metric reports repository 412, developers can configure custom metric reports (e.g., dashboards) to view instantaneous or run-time indicators of system load, service usage, and so forth. Accordingly, the predefined metric reports repository 412 includes predefined metric reports that are currently used, predefined metric reports that were previously used, and predefined metric reports that have never been used by metric reporting system users.

Accordingly, in at least one embodiment, the blocklist generation system 102 predicts unutilized digital metrics by comparing the queried dashboard metrics from the metric reporting system 114 against the generated sample set. For example, the blocklist generation system 102 can predict that dashboard metrics existing within the predefined metric reports repository 412 but not included in or referenced by the sample set are unutilized digital metrics.

Additionally or alternatively, the blocklist generation system 102 can query most-used or most-frequently-used dashboard metrics from the metric reporting system 114—instead of or in addition to querying all dashboard metrics available via the metric reporting system 114. For example, the blocklist generation system 102 can query dashboard metrics with use-counts above a threshold amount.

In an additional embodiment, the blocklist generation system 102 can query related dashboard metrics from the metric reporting system 114. To illustrate, in one or more embodiments, users of the metric reporting system 114 may frequently access multiple or related predefined metric reports (e.g., in a particular pattern, frequency, sequence, or time-frame). For example, in at least one embodiment, the metric reporting system 114 stores predefined metric reports in the predefined metric reports repository 412 in a graph data structure where each predefined metric report is connected to other predefined metric reports. For example, the predefined metric reports repository 412 can include a knowledge graph with nodes corresponding to particular reports and edges defined by interrelated associations between the nodes (e.g., common users accessing a report or sequential patterns of accessing a document). Additionally, the metric reporting system 114 can add weights to each edge connecting the predefined metric reports in the graph, where the weight of an edge between two predefined metric reports represents the relevance or connection between predefined metric reports (e.g., a connectivity strength).

In some implementations the graph can include nodes that correspond to variety of digital items. For example, blocklist generation system 102 can generate a knowledge graph that includes nodes representing dashboards, individual digital metrics, alerts, etc., connected by edges reflecting connections between the digital items (e.g., accessed by same user, containing similar digital metrics, accessed within similar time periods, etc.). The blocklist generation system 102 can then crawl the knowledge graph to identify similar digital metrics to include or exclude from the blocklist.

For instance, the blocklist generation system 102 can query or identify groups of dashboard metrics according to the measure of relatedness. In at least one embodiment, the blocklist generation system 102 further predicts unutilized digital metrics by comparing the identified groups of dashboard metrics against the sample set. For example, the blocklist generation system 102 can compare the identified groups of dashboard metrics against the sample set in further view of the dashboard metrics within the predefined metric reports repository 412 to identify or predict dashboard metrics that are rarely or never utilized by metric requesting devices 118.

In some embodiments, for example, the blocklist generation system 102 identifies a particular digital metric in the sample set. The blocklist generation system 102 then identifies that particular digital metric in the knowledge graph and crawls the knowledge graph (e.g., dashboards or other node) to identify other digital metrics that are related to the particular digital metric via edges of the knowledge graph. In one or more embodiments, the blocklist generation system 102 then determines that these related digital metrics should not be added to the metric blocklist, due to their being related to the particular digital metric within the knowledge graph. In a similar manner, the blocklist generation system 102 can also identify digital metrics to exclude/remove from the blocklist (e.g., by identifying metrics to allow and crawling the knowledge graph to identify other metrics to allow).

In one or more embodiments, as further shown in FIG. 4, the blocklist generation system 102 further or alternatively predicts the unutilized digital metrics based on the sample set in connection with information associated with the alerting system 112. In one or more embodiments, the alerting system 112 is associated with predefined alerts that users can initialize or run. For example, once a user initializes a predefined alert, the alerting system 112 requests and checks alert metrics associated with the predefined alert to determine whether one or more conditions are met. In response to determining that one or more of the conditions are met, the alerting system 112 generates a report, logs a warning, generates a notification, etc. Accordingly, in at least one embodiment, the predefined alerts repository 410 stores predefined alerts that are infrequently or never run or initialized by the metric requesting devices 118.

In some implementations, the alerting system 112 includes alert queries that reference a single metric or a group of metrics. For example, the alerting system 112 can include a query for a single metric to determine whether to trigger an alert (e.g., when system bandwidth utilization reaches a threshold level. Similarly, the alerting system 112 can include a query from a group of metrics to trigger an alert.

In at least one embodiment, the blocklist generation system 102 predicts unutilized metrics by comparing the sample list to alert metrics referenced by predefined alerts in the predefined alerts repository 410. For example, similar to the processes discussed above with regard to information from the metric reporting system 114, the blocklist generation system 102 can predict unutilized metrics by identifying one or more alert metrics referenced by predefined alerts in the predefined alerts repository 410 that are not referenced by the sample list.

In one or more embodiments, the blocklist generation system 102 predicts unutilized digital metrics based on the sample set in connection with information from both the alerting system 112 and the metric reporting system 114. For example, in one or more embodiments, the blocklist generation system 102 predicts unutilized digital metrics by identifying digital metrics referenced within the predefined alerts repository 410 and the predefined metric reports repository 412 that are not referenced by the sample set.

As further shown in FIG. 4, the blocklist generation system 102 performs an act 408 of generating a metric blocklist from the predicted digital metrics. For example, in one or more embodiments, the blocklist generation system 102 generates the metric blocklist including the predicted digital metrics. In some embodiments, the predicted digital metrics are associated with a prediction score indicating a likelihood that the associated digital metrics will not be utilized by the metric requesting devices 118. Accordingly, such embodiments, the blocklist generation system 102 generates the metric blocklist including digital metrics with prediction scores that satisfy a threshold score (e.g., more than 80% likely).

In one or more embodiments, the blocklist generation system 102 generates the metric blocklist in various ways. For example, in one or more embodiments, the blocklist generation system 102 generates the metric blocklist as a comma delimited file of blocked digital metric names. In some embodiment, the blocklist generation system 102 generates the metric blocklist as a linked list or table of digital metric names and all the tags associated with each of the listed digital metric names. For example, the blocklist generation system 102 can generate the metric blocklist to indicate that either a digital metric and all of its associated tags are blocked, or that a subset of tags associated with a digital metric are blocked. In one or more embodiments, the blocklist generation system 102 generates the metric blocklist including any other suitable data structure (e.g., a hash table, a hierarchically structured tree).

As mentioned above, in one or more embodiments, the blocklist generation system 102 generates a metric blocklist based on other metadata associated with monitored digital metric requests. For example, as shown in FIG. 5, the blocklist generation system 102 performs an act 500 of monitoring digital requests for digital metrics for a threshold period of time. For example, as discussed above with reference to FIG. 4, the blocklist generation system 102 monitors digital requests by identifying digital requests for digital metrics transmitted by one or more of the metric requesting devices 118. Additionally, as shown in FIG. 5, in at least one embodiment, the blocklist generation system 102 further generates metadata associated with requested digital metrics during the threshold period of time. In one or more embodiments, the blocklist generation system 102 generates metadata including a first-read timestamp, a last-read timestamp, a first-write timestamp, and/or a last-write timestamp.

In more detail, in one or more embodiments, the blocklist generation system 102 generates metadata associated with requested digital metrics during the threshold period of time that indicates types of requests associated with the digital metrics, as well as frequency of the requests associated with the digital metrics. For example, as illustrated in FIG. 5, the blocklist generation system 102 performs an act 502 of identifying a request for a digital metric at a time t₁. In response to identifying the request for the digital metric, the blocklist generation system 102 determines whether metadata associated with the requested digital metric already exists in a metadata repository 508. In response to determining that no metadata exists (e.g., this is the first request associated with the digital metric), the blocklist generation system 102 determines a type of the request (e.g., a read request for the digital metric), then generates metadata indicating the time associated with the first time that type of request was made in connection with the digital metric. For example, the blocklist generation system 102 generates metadata indicating the first read time for the digital metric (e.g., “CPUCall”) is t₁.

The blocklist generation system 102 updates the metadata associated with the digital metric for each additional request associated with the same digital metric during the threshold period of time. For example, in response to performing an act 504 of identifying another read request for the digital metric at the time t₂ during the threshold period of time, the blocklist generation system 102 updates the metadata for the digital metric within the metadata repository 508 to include a last read time t₂. Additionally, in response to performing an act 506 of identifying yet another read request for the digital metric at the time t₃ during the threshold period of time, the blocklist generation system 102 updates the last read time to t₃. The blocklist generation system 102 similarly generates and updates metadata for the first and last write requests associated with the digital metric (e.g., the digital metric “CPUCall”). The blocklist generation system 102 generates and stores the same metadata for each digital metric requested by the metric requesting devices 118 during the threshold period of time.

In additional or alternative embodiments, the blocklist generation system 102 generates one or more additional metadata tags for the digital metrics requested during the threshold period of time. For example, in at least one embodiment, upon initial generation of metadata associated with a requested digital metric, the blocklist generation system 102 queries the alerting system 112 and/or metric reporting system 114 for one or more predefined alerts and/or predefined metric reports that reference the requested digital metric. The blocklist generation system 102 can generate the additional metadata tag as a Boolean value (e.g., 1 to indicate that the requested digital metric is referenced by at least one predefined alert and/or predefined metric report, 0 to indicate that the requested digital metric is not referenced by at least one predefined alert and/or predefined metric report). Alternatively, the blocklist generation system 102 can generate the additional metadata tag as a numerical value indicating a number of predefined alerts and/or predefined metric reports that reference the requested digital metric. Alternatively, the blocklist generation system 102 can generate the additional metadata tag as a string of names of predefined alerts and/or predefined metric reports that reference the requested digital metric.

After the threshold period of time elapses, the blocklist generation system 102 performs an act 510 of predicting digital metrics that the metric requesting devices 118 will not utilize. For example, in one or more embodiments, the blocklist generation system 102 predicts unutilized digital metrics based on the metadata generated during the threshold period of time. To illustrate, the blocklist generation system 102 can predict the unutilized digital metrics include those with last read times and/or last write times that occurred outside a predetermined timeframe (e.g., are more than 2 weeks old, are more than a month old). In another embodiment, the blocklist generation system 102 predicts that unutilized digital metrics include those with a first read time and/or a first write time, the first read time and/or first write time was outside of a threshold period, and there is no last read time and/or last write time (e.g., indicating that those digital metrics were only requested once during the threshold period of time). In yet another embodiment, the blocklist generation system 102 predicts that unutilized digital metrics include those with a first read time and/or a first write time, but no metadata indicating that they are referenced by a predefined alert and/or predefined metric report.

For example, the blocklist generation system 102 can predict that a digital metric will be utilized if its first write time or last write time is in the last 60 days. Additionally, the blocklist generation system 102 can predict that a digital metric will be utilized if its first read time is in the last 60 days. Furthermore, the blocklist generation system 102 can predict that a digital metric should not be blocked if it has ever been read (e.g., it has at least a first read time). Moreover, the blocklist generation system 102 can predict that a digital metric should not be blocked if it is referenced by either of the alerting system 112 or the metric reporting system 114.

Additionally or alternatively, the blocklist generation system 102 further predicts the unutilized digital metrics based on the generated metadata in connection with information from the alerting system 112 and/or the metric reporting system 114. For example, as discussed above with reference to FIG. 4, the blocklist generation system 102 queries or identifies dashboard metrics referenced by predefined metric reports from the predefined metric reports repository 412. Similarly, the blocklist generation system 102 queries or identifies alert metrics referenced by predefined alerts from the predefined alert system 410.

In at least one embodiment, the blocklist generation system 102 predicts unutilized digital metrics based on an analysis of the generated metadata in connection with the identified dashboard metrics and/or alert metrics. For example, the blocklist generation system 102 can predict that a dashboard metric and/or alert metric is an unutilized digital metric if no metadata associated with the dashboard metric and/or alert metric exists in the metadata repository 508. Additionally or alternatively, the blocklist generation system 102 can predict that a dashboard metric and/or alert metric is an unutilized digital metric if there is a first read time and/or first write time associated with the dashboard metric and/or alert metric in the metadata repository 508, but no last read time and/or last write time (e.g., the dashboard metric and/or alert metric was only requested once during the threshold period of time). Additionally or alternatively, the blocklist generation system 102 can predict that a dashboard metric and/or alert metric is an unutilized digital metric if a last read time and/or last write time associated with the dashboard metric and/or alert metric within the metadata repository 508 is outside a predetermined time window (e.g., more than a month old, more than 6 months old).

Additionally, as shown in FIG. 5, the blocklist generation system 102 performs an act 512 of generating a metric blocklist from the predicted digital metrics. For example, as discussed above with regard to FIG. 4, the blocklist generation system 102 generates the metric blocklist including the predicted unutilized digital metrics. Additionally or alternatively, the blocklist generation system 102 generates the metric blocklist including digital metrics represented in the metadata repository 508 with prediction scores that satisfy a threshold score.

In additional embodiments, the blocklist generation system 102 predicts unutilized digital metrics (e.g., as in the act 406 shown in FIG. 4 and/or the act 510 shown in FIG. 5) utilizing a machine learning model. For example, the blocklist generation system 102 can utilize a machine learning model trained to predict unutilized digital metrics from an input vector including the sample set, the metadata repository 508, metric names, metric attributes (e.g., tag names), sample metric values, one or more dashboard metrics queried from the predefined metric reports repository 412, and/or one or more alert metrics queried from the predefined alerts repository 410. For example, in response to providing such an input vector to the trained machine learning model, the blocklist generation system 102 can receive a listing of one or more predicted unutilized digital metrics. Additionally or alternatively, the blocklist generation system 102 can receive prediction scores from the machine learning model for the digital metrics, where the prediction scores indicate a likelihood that the digital metrics are unutilized digital metrics.

In more detail, the blocklist generation system 102 generates the machine learning model in various ways. For example, in some embodiments, the blocklist generation system 102 implements the machine learning model as a decision tree. In additional embodiments, the blocklist generation system 102 implements the machine learning model as a neural network, k-nearest neighbor, deep learning model, or a combination of the foregoing.

As just mentioned, the blocklist generation system 102 can generate the machine learning model as a neural network model. In particular, the neural network can include a model of interconnected artificial neurons (or layers) that communicate and learn to approximate complex functions and generate outputs based on a plurality of inputs provided to the model. In particular, a neural network includes a computer-implemented algorithm that implements deep learning techniques to analyzes input to make predictions. In some embodiments, the blocklist generation system 102 generates the neural network employing supervised learning, while in other embodiments the blocklist generation system 102 generates the neural network employing unsupervised learning or reinforced learning. Examples of neural networks include deep convolutional neural networks, generative adversarial neural networks, and recurrent neural networks (e.g., long short term memory neural networks or LSTMs).

In one or more embodiments, the blocklist generation system 102 trains the machine learning model with ground truth information. For example, the blocklist generation system 102 utilizes ground truth predictions of unutilized digital metrics and corresponding known input vectors including one or more of a sample set, a metadata repository, metric names, metric attributes, sample metric values, dashboard metrics, and alert. To illustrate, the blocklist generation system 102 trains the machine learning model by providing a known input vector to the machine learning model, receiving a training prediction of unutilized digital metrics, comparing the training prediction to the corresponding ground truth prediction, and then back-propagating a measure of loss based on the comparison. The blocklist generation system 102 can continue this process until the measure of loss is minimized. In one or more embodiments, the blocklist generation system 102 re-trains the machine learning model periodically (e.g., every week, every month), and/or after a threshold number of uses (e.g., after predicting 10,000 unutilized digital metrics).

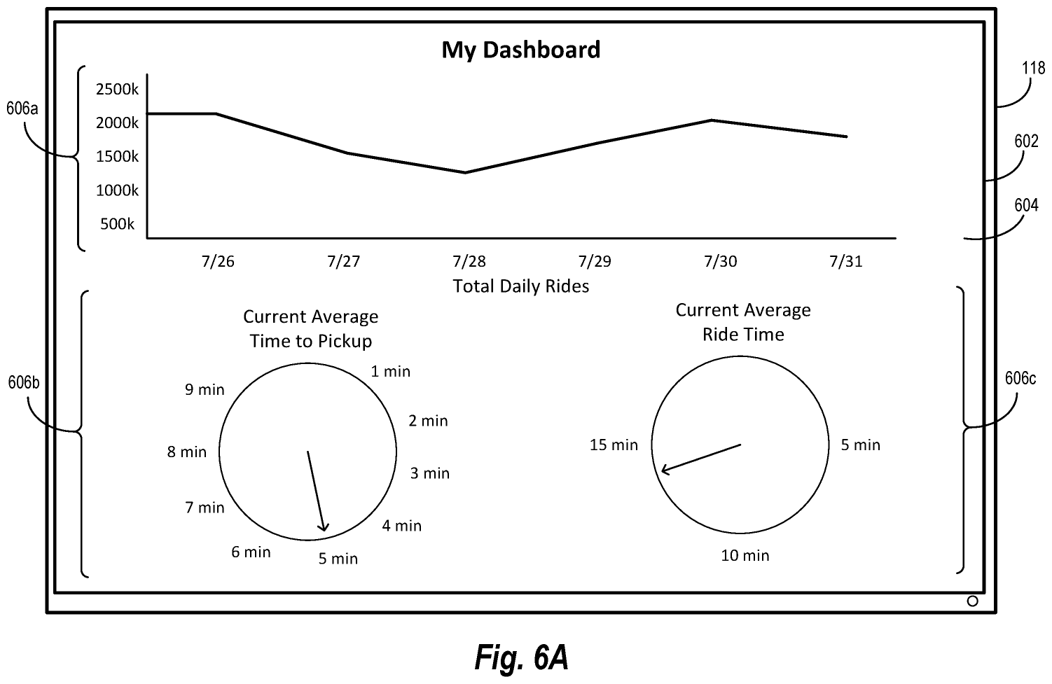

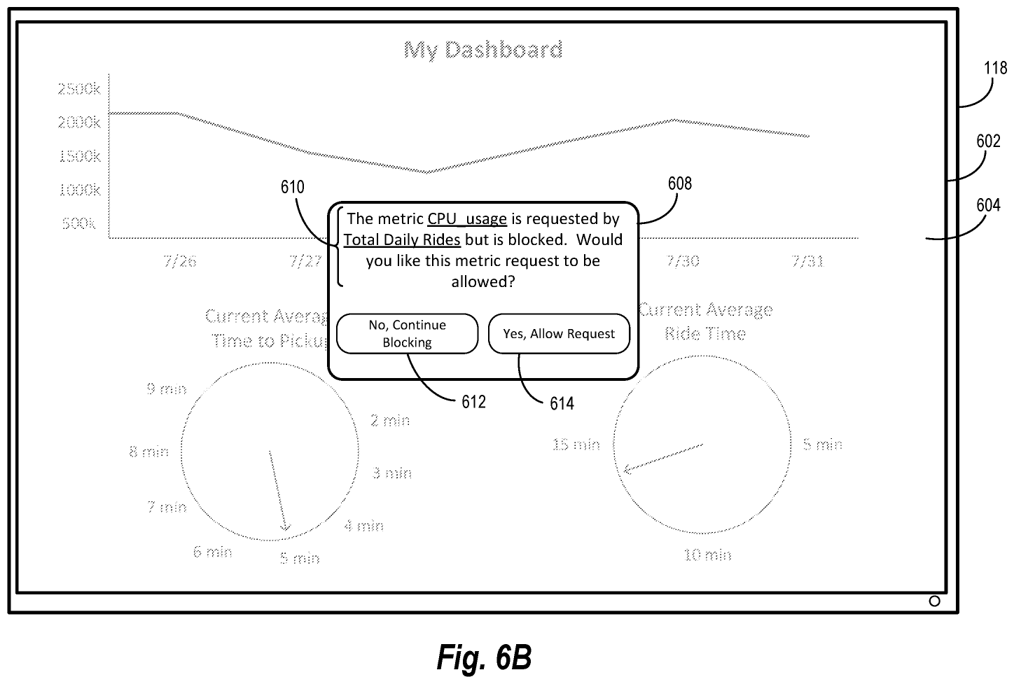

In one or more embodiments, the blocklist generation system 102 generates notifications associated with a generated metric blocklist and provides those notifications to metric requesting device(s) 118. FIGS. 6A and 6B illustrate the blocklist generation system 102 providing generated notifications to a metric requesting client device 118 in response to blocking one or more digital read requests associated with one or more digital metrics. For example, in one or more embodiments as shown in FIG. 6A, metric reporting system 114 generates and provides a dashboard user interface 604 on a display 602 of a metric requesting device 118 (e.g., the computing client device 105).

In at least one embodiment, a user of the metric requesting device 118 configures the dashboard user interface 604 including multiple predefined metric reports 606a, 606b, and 606c. For example, in one or more embodiments, the metric reporting system 114 generates the predefined metric reports 606a-606c in response to initializing, running, or compiling user-configured computer code, rules, or actions. To illustrate, the metric reporting system 114 generates the predefined metric report 606a in response to initializing a user-configured script that causes the metric reporting system 114 to request multiple digital metrics from one or more of the metric storage devices 108a-108c, and generate a graph based on the requested digital metrics received from the metric storage devices 108a-108c. As shown in FIG. 6A, the metric reporting system 114 generates the predefined metric reports 606a-606c including any of possible data displays (e.g., charts, graphs, counters, dials, histograms, animations, and so forth).

In one or more embodiments, and as discussed above, the blocklist generation system 102 receives the digital metric requests from the metric reporting system 114 on the metric requesting device 118. Additionally, as further discussed above, the blocklist generation system 102 compares the requested digital metrics to a metric blocklist generated according to one or more of the processes described above with reference to FIGS. 3-5. Moreover, the blocklist generation system 102 blocks one or more of the digital requests based on the comparison to the metric blocklist.

In at least one embodiment, in response to blocking one or more of the digital requests based on the metric blocklist, the blocklist generation system 102 further generates a notification for display on the metric requesting device 118. For example, as shown in FIG. 6B, the blocklist generation system 102 generates the block notification 608. In one or more embodiments, the blocklist generation system 102 generates the block notification 608 including information 610 detailing the one or more digital metrics associated with the blocked digital requests (e.g., “CPU usage”), as well as the predefined metric report associated with the blocked digital requests (e.g., “Total Daily Rides”).

Moreover, as shown in FIG. 6B, the blocklist generation system 102 generates the block notification 608 including a confirm option element 612 and an allow option element 614. For example, in response to a detected selection of the confirm option element 612, the blocklist generation system 102 maintains the one or more digital metrics referenced in the block notification 608 in the metric blocklist. In the event that the block notification 608 references multiple digital metrics, the blocklist generation system 102 can provide additional options to continue blocking a subset of the referenced digital metrics in response to a detected selection of the confirm option element 612.

In response to a detected selection of the allow option element 614, the blocklist generation system 102 can “unblock” the referenced one or more digital metrics in any of various ways. For example, in one or more embodiments, the blocklist generation system 102 removes or unblocks the one or more digital metrics from or relative to the metric blocklist. In some embodiments, the blocklist generation system 102 adds the one or more digital metrics to an allow list. For example, the blocklist generation system 102 generates and maintains the allow list such the blocklist generation system 102 compares future digital requests for digital metrics against the allow list prior or subsequent to comparison against the metric blocklist. In other words, the blocklist generation system 102 utilizes the allow list as an “escape hatch” for digital metrics that should not be blocked. In at least one embodiment, in the event that the block notification 608 references multiple digital metrics, the blocklist generation system 102 can generate a breakout listing of confirm/allow options associated with each digital metric in response to a detected selection of the confirm option element 612 and/or the allow option element 614.

In one or more embodiments, the blocklist generation system 102 handles the allow list in various ways. For example, in one or more embodiments, the blocklist generation system 102 maintains the allow list until the metric blocklist is updated. To illustrate, the blocklist generation system 102 can update or re-generate a metric blocklist at regular intervals (e.g., every week), or after a threshold number of digital requests for digital metrics. Each time the blocklist generation system 102 updates or re-generates the metric blocklist, the blocklist generation system 102 can also re-analyze the digital metrics referenced by the allow list. For example, the blocklist generation system 102 may add digital metrics from the allow list back onto the blocklist in response to determining that those digital metrics have not been requested for a threshold amount of time.

In additional or alternative embodiments, the blocklist generation system 102 monitors detected selections of the confirm option element 612 and/or allow option element 614 in connection with digital metrics to further train or increase the accuracy of the process of generating the metric blocklist. For example, in one or more embodiments, the blocklist generation system 102 utilizes the monitored selections to further train a machine learning model that predicts digital metrics that metric requesting devices 118 will not utilize. In some embodiments, the blocklist generation system 102 utilizes the monitored selections to otherwise learn preferences associated with the one or more metric requesting devices 118.

While the example illustrated in FIGS. 6A and 6B is described in connection with a dashboard user interface 604 generated by the metric reporting system 114 on the computing client device 105, the blocklist generation system 102 can generate and provide block notifications in connection with any of the metric requesting devices 118 in the distributed computing system 106. For example, in one or more embodiments, the blocklist generation system 102 generates and provides a block notification on the computing client device 105 in connection with one or more user interfaces generated by the alerting system 112.

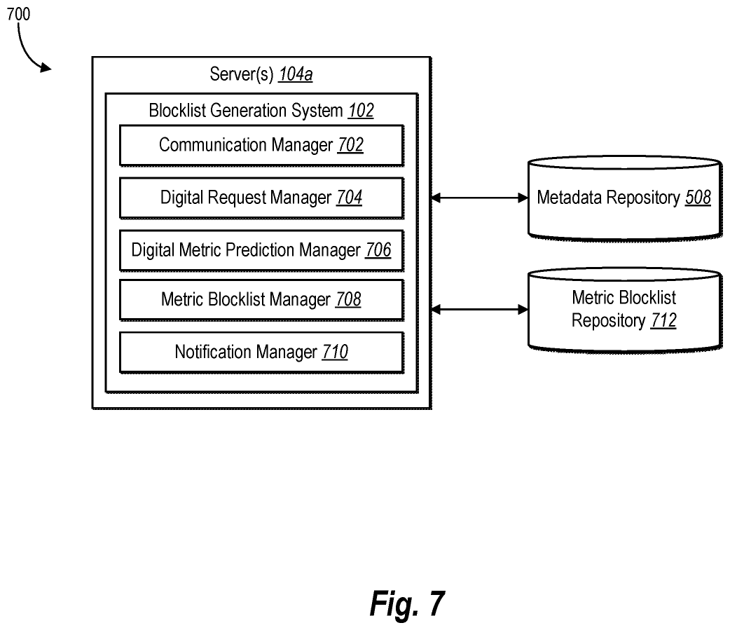

Turning now to FIG. 7, additional detail is provided regarding a computing system 700 including components and capabilities of the blocklist generation system 102 in accordance with one or more embodiments. As shown, in one or more embodiments, the blocklist generation system 102 is implemented by the server(s) 104a. In some embodiments, some or all of the components of the blocklist generation system 102 can be implemented by a single device (e.g., any of the server(s) 104a-104c, the computing client device 105), or by multiple devices. As shown, the blocklist generation system 102 includes a communication manager 702, a digital request manager 704, a digital metric prediction manager 706, a metric blocklist manager 708, and a notification manager 710. In at least one embodiment, the system 700 further includes the metadata repository 508 and a metric blocklist repository 712. Each of these components is discussed in turn below.

As just mentioned, and as shown in FIG. 7, the blocklist generation system 102 includes the communication manager 702. In one or more embodiments, the communication manager 702 handles all communication tasks between the blocklist generation system 102 and other computing devices within the distributed computing system 106. For example, the communication manager 702 receives or identifies digital requests for digital metrics from one or more of the metric requesting device(s) 118. Additionally, the communication manager 702 enables non-blocked digital requests to be transmitted (e.g., passed through) to one or more metric storage devices 108a-108c. Moreover, in response to the blocklist generation system 102 blocking a digital request for a digital metric from a metric requesting device 118, the communication manager 702 transmits a block notification to the metric requesting device 118.

As further shown in FIG. 7, the blocklist generation system 102 includes the digital request manager 704. In one or more embodiments, the digital request manager 704 monitors digital requests for digital metrics from the metric requesting device(s) 118 during a threshold period of time. For example, the digital request manager 704 identifies digital requests during the threshold period of time, and generates a sample set of digital metrics referenced by the identified digital requests. Additionally, in one or more embodiments, the digital request manager 704 generates and maintains (e.g., within the metadata repository 508) metadata associated with the identified digital requests (e.g., first read time, last read time, first write time, last write time).

As mentioned above, and further shown in FIG. 7, the blocklist generation system 102 includes the digital metric prediction manager 706. In one or more embodiments, the digital metric prediction manager 706 predicts digital metrics that the metric requesting device(s) 118 will not utilize. For example, as discussed above, the digital metric prediction manager 706 predicts unutilized digital metrics based on any combination of a generated sample set, generated metadata, and usage information from one or more of the metric requesting device(s) 118 of the distributed computing system 106 (e.g., predefined alerts, predefined metric reports).

In at least one embodiment, the digital metric prediction manager 706 predicts one or more tags of a digital metric that will not be utilized by the metric requesting devices 118. For example, some digital metrics are associated with one or more tags or subsets of information. Accordingly, the digital metric prediction manager 706 can utilize the same techniques described above with greater granularity to predict specific tags of a digital metric that will not be utilized by the metric requesting devices 118.

In one or more embodiments, the digital metric prediction manager 706 predicts unutilized digital metrics based on rules, heuristics, and/or algorithms. Additionally, in at least one embodiment, the digital metric prediction manager 706 utilizes a machine learning model to generate unutilized digital metric predictions. For example, the digital metric prediction manager 706 can utilize a machine learning model trained to generate either predicted digital metrics or prediction scores associated with digital metrics in response to receiving an input vector including any of the generated sample set, generated metadata, usage information from one or more of the metric requesting device(s) 118, digital metric names, digital metric attributes (e.g., specific tag names), and/or recently utilized digital metric.

As further mentioned above, and as shown in FIG. 7, the blocklist generation system 102 includes the metric blocklist manager 708. In one or more embodiments, the metric blocklist manager 708 generates a metric blocklist based on digital metrics predicted to not be utilized by one or more metric requesting devices 118. For example, in one or more embodiments, the metric blocklist manager 708 generates the metric blocklist including all of the predicted digital metrics. In another embodiment, the metric blocklist manager 708 generates the metric blocklist including digital metrics with prediction scores above a threshold amount. In at least one embodiment, the metric blocklist manager 708 maintains the metric blocklist in a metric blocklist repository 712.

Additionally, the metric blocklist manager 708 can distribute and manage the metric blocklist among one or more computing devices within the distributed computing system 106. Alternatively, the metric blocklist manager 708 can maintain the metric blocklist at a central proxy server (e.g., a network gateway of the distributed computing system 106).

In one or more embodiments, the metric blocklist manager 708 also compares digital metrics referenced by identified digital requests to the metric blocklist to determine whether the identified digital requests should be blocked. For example, the metric blocklist manager 708 blocks a digital request for a digital metric that exists on the metric blocklist. Additionally, in one or more embodiments, the metric blocklist manager 708 blocks one or more tags of a requested digital metric based on the metric blocklist.

In at least one embodiment, the metric blocklist manager 708 generates or otherwise enables an allow list. For example, in response to a user indication to allow a blocked digital metric, the metric blocklist manager 708 generates an allow list including the digital metric. The metric blocklist manager 708 further transmits the previously blocked digital request to one or more metric storage devices 108a-108c for processing. Additionally or alternatively, the metric blocklist manager 708 allows blocked digital metrics by removing those digital metrics from the metric blocklist.

In one or more embodiments, the metric blocklist manager 708 periodically updates or regenerates a metric blocklist. For example, the metric blocklist manager 708 can re-analyze information from the alerting system 112 and/or the metric reporting system 114 to determine whether digital metrics referenced by the metric blocklist should continue to be blocked. Similarly, the metric blocklist manager 708 can re-start the threshold period of time during which the digital request manager 704 monitors digital requests, then update the metric blocklist based on the updated sample set.

In one or more embodiments, the metric blocklist manager 708 can store digital write requests associated with digital metric referenced by the metric blocklist instead of blocking those requests. For example, in one or more embodiments, the metric blocklist manager 708 stores the digital metrics associated with the blocks digital write requests in super-compressed data storage. Thus, if, at some point in the future, those digital metrics are no longer referenced by the metric blocklist, the metric blocklist manager 708 can extract the stored values from super-compressed data storage to provide to one or more metric requesting devices 118.

As shown in FIG. 7, and as mentioned above, the blocklist generation system 102 includes the notification manager 710. In one or more embodiments, the notification manager 710 generates and provides notifications in response to the metric blocklist manager 708 blocking one or more digital metrics. For example, the notification manager 710 generates notifications including information regarding the blocked digital metrics, as well as options for either confirming or reversing the block. In at least one embodiment, the notification manager 710 generates notifications according to user preferences or configurations. For example, in some embodiments, based on user preferences, the notification manager 710 generates a notification for a blocked digital metric only the first time that digital metric is blocked.

Each of the components of the system 700 can include software, hardware, or both. For example, the components of the system 700 can include one or more instructions stored on a computer-readable storage medium and executable by processors of one or more computing devices, such as a client device or a server device. When executed by the one or more processors, the computer-executable instructions of the blocklist generation system 102 can cause the computing device(s) (e.g., the server(s) 104a) to perform the methods described herein. Alternatively, the components of the system 700 can include hardware, such as a special-purpose processing device to perform a certain function or group of functions. Alternatively, the components of the system 700 can include a combination of computer-executable instructions and hardware.

Furthermore, the components of the system 700 may, for example, be implemented as one or more operating systems, as one or more stand-alone applications, as one or more modules of an application, as one or more plug-ins, as one or more library functions or functions that may be called by other applications, and/or as a cloud-computing model. Thus, the components of the system 700 may be implemented as a stand-alone application, such as a desktop or mobile application. Furthermore, the components of the system 700 may be implemented as one or more web-based applications hosted on a remote server.

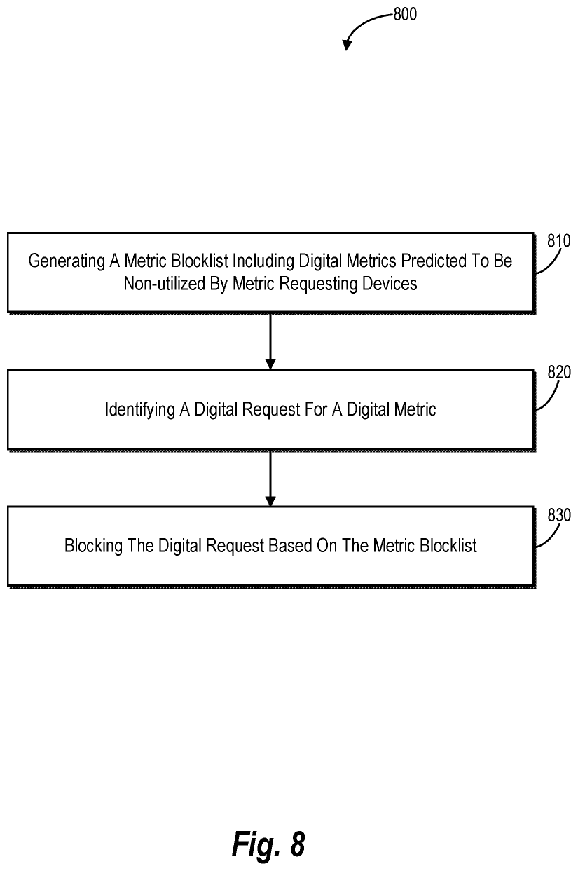

FIGS. 1-7, the corresponding text, and the examples provide several different systems, methods, techniques, components, and/or devices of the blocklist generation system 102 in accordance with one or more embodiments. In addition to the above description, FIG. 8 illustrates a flowchart of a series of acts 800 in a method of intelligently blocking digital requests for digital metrics predicted to not be utilized by metric requesting devices in accordance with one or more embodiments. The blocklist generation system 102 may perform one or more acts of the series of acts 800 in addition to or alternatively to one or more acts described in conjunction with other figures. While FIG. 8 illustrates acts according to a respective embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes and act 810 of generating a metric blocklist including digital metrics predicted to be unutilized by metric requesting devices. In particular the act 810 can involve generating a metric blocklist for a distributed computing system comprising metric requesting devices and metric storage devices by predicting a plurality of digital metrics that metric requesting devices will not utilize.

In one or more embodiments, the series of acts 800 includes acts of: monitoring, for a threshold period of time, digital requests for digital metrics of the distributed computing system from metric requesting devices, generating a sample set of requested digital metrics from the monitored digital requests, and predicting the plurality of digital metrics that metric requesting devices will not utilize based on the sample set of requested digital metrics. Additionally, in at least one embodiment, the series of acts 800 includes identifying one or more predefined metric reports that reference one or more dashboard metrics, wherein predicting the plurality of digital metrics that metric requesting devices will not utilize is further based on the one or more dashboard metrics referenced by the one or more predefined metric reports. Additionally or alternatively, in at least one embodiment, the series of acts 800 includes identifying one or more alert metrics corresponding to one or more predefined alerts, wherein predicting the plurality of digital metrics that metric requesting devices will not utilize is further based on the one or more alert metrics.

In one or more embodiments, the series of acts 800 includes monitoring, for a threshold period of time, digital requests for digital metrics of the distributed computing system from metric requesting devices to generate a repository of metadata by generating, for each of the digital metrics referenced by the monitored digital requests: a first-read timestamp, a last-read timestamp, a first-write timestamp, or a last-write timestamp. Additionally, the series of acts 800 can include predicting the plurality of digital metrics that metric requesting devices will not utilize based on the repository of metadata associated with digital metrics referenced by the monitored digital requests.

In one or more embodiments, the series of acts 800 includes an act of identifying an additional digital request from the metric requesting device associated with additional digital metrics of the distributed computing system. Additionally, in at least one embodiment, the series of acts 800 further includes, based on comparing the additional digital metrics with the metric blocklist, allowing the digital request associated with the additional digital metrics of the distributed computing system.

As shown in FIG. 8, the series of acts 800 includes and act 820 of identifying a digital request for a digital metric. In particular the act 820 can involve identifying a digital request from a metric requesting device associated with one or more digital metrics of the distributed computing system. For example, identifying the digital request from the metric requesting device can include one of: identifying a digital request to write the one or more digital metrics of the distributed computing system to at least one of the metric storage devices, or identifying a digital request to read the one or more digital metrics of the distributed computing system from at least one of the metric storage devices.

As shown in FIG. 8, the series of acts 800 includes and act 830 of blocking the digital request based on the metric blocklist. In particular the act 830 can involve, based on comparing the one or more digital metrics with the metric blocklist, blocking the digital request associated with the one or more digital metrics of the distributed computing system. For example, the series of acts 800 can include accessing the metric blocklist and blocking the digital request associated with the one or more digital metrics of the distributed computing system via at least from one of: the metric requesting device, a network gateway of the distributed computing system, a metric report system, or an alerting system within the distributed computing system.

In one or more embodiments, the series of acts 800 includes, in response to blocking the digital request associated with the one or more digital metrics of the distributed computing system, providing, for display, a block notification to the metric requesting device indicating that the digital request associated with the one or more digital metrics is blocked. For example, providing the block notification can further include providing a user interface option element to unblock the one or more digital metrics of the distributed computing system relative to the metric blocklist. In at least one embodiment, the series of acts 800 includes upon detecting a selection of the user interface option element to unblock the one or more digital metrics of the distributed computing system, identifying an additional digital request from at least one metric requesting device associated with the one or more digital metrics, and allowing the additional digital request associated with the one or more digital metrics.

FIG. 9 illustrates a block diagram of an example computing device 900 that may be configured to perform one or more of the processes described above. One will appreciate that one or more computing devices, such as the computing device 900 may represent the computing devices described above (e.g., the computing system 800, the server(s) 104a-104c, the computing client device 105). In one or more embodiments, the computing device 900 may be a mobile device (e.g., a mobile telephone, a smartphone, a PDA, a tablet, a laptop, a camera, a tracker, a watch, a wearable device, etc.). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of the computing device 900 to each other.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating a metric blocklist for a distributed computing system comprising metric requesting devices and metric storage devices by predicting a plurality of digital metrics that metric requesting devices will not utilize;
identifying a digital request from a metric requesting device associated with one or more digital metrics of the distributed computing system; and
based on comparing the one or more digital metrics with the metric blocklist, blocking the digital request associated with the one or more digital metrics of the distributed computing system.

2. The method as recited in claim 1, further comprising:
identifying an additional digital request from the metric requesting device associated with additional digital metrics of the distributed computing system; and
based on comparing the additional digital metrics with the metric blocklist, allowing the digital request associated with the additional digital metrics of the distributed computing system.

3. The method as recited in claim 1, wherein identifying the digital request from the metric requesting device comprises one of:
identifying a digital request to write the one or more digital metrics of the distributed computing system to at least one of the metric storage devices; or
identifying a digital request to read the one or more digital metrics of the distributed computing system from at least one of the metric storage devices.

4. The method as recited in claim 1, further comprising:
monitoring, for a threshold period of time, digital requests for digital metrics of the distributed computing system from metric requesting devices;
generating a sample set of requested digital metrics from the monitored digital requests; and
predicting the plurality of digital metrics that metric requesting devices will not utilize based on the sample set of requested digital metrics.

5. The method as recited in claim 4, further comprising:
identifying one or more predefined metric reports that reference one or more dashboard metrics; and
wherein predicting the plurality of digital metrics that metric requesting devices will not utilize is further based on the one or more dashboard metrics referenced by the one or more predefined metric reports.

6. The method as recited in claim 4, further comprising:
identifying one or more alert metrics corresponding to one or more predefined alerts; and
wherein predicting the plurality of digital metrics that metric requesting devices will not utilize is further based on the one or more alert metrics.

7. A system comprising:
at least one processor; and
a non-transitory computer readable storage medium comprising instructions that, when executed by the at least one processor, cause the system to:
generate a metric blocklist for a distributed computing system comprising metric requesting devices and metric storage devices by predicting a plurality of digital metrics that metric requesting devices will not utilize;
identify a digital request from a metric requesting device associated with one or more digital metrics of the distributed computing system; and
based on comparing the one or more digital metrics with the metric blocklist, block the digital request associated with the one or more digital metrics of the distributed computing system.

8. The system as recited in claim 7, further comprising instructions that, when executed by the at least one processor, cause the system to:
monitor, for a threshold period of time, digital requests for digital metrics of the distributed computing system from metric requesting devices to generate a repository of metadata by generating, for each of the digital metrics referenced by the monitored digital requests: a first-read timestamp, a last-read timestamp, a first-write timestamp, or a last-write timestamp; and
predict the plurality of digital metrics that metric requesting devices will not utilize based on the repository of metadata associated with digital metrics referenced by the monitored digital requests.

9. The system as recited in claim 7, further comprising instructions that, when executed by the at least one processor, cause the system to access the metric blocklist and block the digital request associated with the one or more digital metrics of the distributed computing system via at least one of: the metric requesting device, a network gateway of the distributed computing system, a metric report system, or an alerting system within the distributed computing system.

10. The system as recited in claim 7, further comprising instructions that, when executed by the at least one processor, cause the system to, in response to blocking the digital request associated with the one or more digital metrics of the distributed computing system, provide, for display, a block notification to the metric requesting device indicating that the digital request associated with the one or more digital metrics is blocked.

11. The system as recited in claim 10, further comprising instructions that, when executed by the at least one processor, cause the system to further provide the block notification to the metric requesting device by providing a user interface option element to unblock the one or more digital metrics of the distributed computing system relative to the metric blocklist.

12. The system as recited in claim 11, further comprising instructions that, when executed by the at least one processor, cause the system to:
upon detecting a selection of the user interface option element to unblock the one or more digital metrics of the distributed computing system, identify an additional digital request from at least one metric requesting device associated with the one or more digital metrics; and
allow the additional digital request associated with the one or more digital metrics.

13. A non-transitory computer readable storage medium comprising instructions that, when executed by at least one processor, cause a computing device to:
generate a metric blocklist for a distributed computing system comprising metric requesting devices and metric storage devices by predicting a plurality of digital metrics that metric requesting devices will not utilize;
identify a digital request from a metric requesting device associated with one or more digital metrics of the distributed computing system; and
based on comparing the one or more digital metrics with the metric blocklist, block the digital request associated with the one or more digital metrics of the distributed computing system.

14. The non-transitory computer readable storage medium as recited in claim 13, further comprising instructions that, when executed by the at least one processor, cause a computing device to:
identify an additional digital request from the metric requesting device associated with additional digital metrics of the distributed computing system; and
based on comparing the additional digital metrics with the metric blocklist, allow the digital request associated with the additional digital metrics of the distributed computing system.

15. The non-transitory computer readable storage medium as recited in claim 13, further comprising instructions that, when executed by the at least one processor, cause a computing device to:
monitor, for a threshold period of time, digital requests for digital metrics of the distributed computing system from metric requesting devices;
generate a sample set of requested digital metrics from the monitored digital requests; and
predict the plurality of digital metrics that metric requesting devices will not utilize based on the sample set of requested digital metrics.

16. The non-transitory computer readable storage medium as recited in claim 15, further comprising instructions that, when executed by the at least one processor, cause a computing device to:
identify one or more predefined metric reports that reference one or more dashboard metrics; and
further predict the plurality of digital metrics that metric requesting devices will not utilize based on the one or more dashboard metrics referenced by the one or more predefined metric reports.

17. The non-transitory computer readable storage medium as recited in claim 15, further comprising instructions that, when executed by the at least one processor, cause a computing device to:
identify one or more alert metrics corresponding to one or more predefined alerts; and
predict the plurality of digital metrics that metric requesting devices will not utilize based on the one or more alert metrics.

18. The non-transitory computer readable storage medium as recited in claim 13, further comprising instructions that, when executed by the at least one processor, cause a computing device to:
monitor, for a threshold period of time, digital requests for digital metrics of the distributed computing system from metric requesting devices to generate a repository of metadata by generating, for each of the digital metrics referenced by the monitored digital requests: a first-read timestamp, a last-read timestamp, a first-write timestamp, or a last-write timestamp; and
predict the plurality of digital metrics that metric requesting devices will not utilize based on the repository of metadata associated with digital metrics referenced by the monitored digital requests.

19. The non-transitory computer readable storage medium as recited in claim 13, further comprising instructions that, when executed by the at least one processor, cause a computing device to, in response to blocking the digital request associated with the one or more digital metrics of the distributed computing system, provide, for display, a block notification to the metric requesting device indicating that the digital request associated with the one or more digital metrics is blocked.

20. The non-transitory computer readable storage medium as recited in claim 19, further comprising instructions that, when executed by the at least one processor, cause a computing device to further provide the block notification to the metric requesting device by providing a user interface option element to unblock the one or more digital metrics of the distributed computing system relative to the metric blocklist.
